(19) United States
(12) Patent Application Publication
(10) Pub. No.: US 2026/0011100 A1
(43) Pub. Date: Jan. 8, 2026

(54) METHODS, SYSTEMS, AND APPARATUSES FOR THREE-DIMENSIONAL VISUALIZATION OF STRUCTURES

(71) Applicant: Pond & Company, Peachtree Corners, GA (US)

(72) Inventors: Cody Owenby, Peachtree Corners, GA (US); Morgane Coleman, Peachtree Corners, GA (US); Patrick Mannella, Peachtree Corners, GA (US); Stephanie Griffith, Peachtree Corners, GA (US)

(21) Appl. No.: 19/258,489

(22) Filed: Jul. 2, 2025

Related U.S. Application Data
(60) Provisional application No. 63/667,232, filed on Jul. 3, 2024.

(51) Int. Cl. G06T 19/20; G06T 13/60

(52) U.S. Cl. CPC G06T 19/20; G06T 13/60; G06T 2219/2004; G06T 2219/2016; G06T 2219/2024

(57) ABSTRACT

Methods, systems, and apparatuses are described for three-dimensional visualization of structures. A computing device receive first data indicative of a structure in a two-dimensional space. The computing device may receive second data indicative of one or more assets associated with a geolocation of the structure in a three-dimensional representation of the Earth's surface. The computing device may determine, based on the first and second data, a three-dimensional model comprising the structure and the assets from a perspective of the structure. The structure and the assets may be aligned to respective geolocation in the three-dimensional representation of the Earth's space. The computing device may cause output of the three-dimensional model in a three-dimensional virtual space via a virtual reality platform of a user device. Based the three-dimensional model a request from the user device, the computing device may update one or more features associated with the structure.

### CROSS-REFERENCE TO RELATED APPLICATIONS

This application claims priority from U.S. Provisional Patent Application No. 63/667,232, filed Jul. 3, 2024, the entire disclosure of which is hereby incorporated herein by reference in its entirety.

### BACKGROUND

In conventional two-dimensional (2D) design, architects and designers create 2D floor plans, elevations, site plans, and details of buildings and structures using drafting tools or software. However, the conventional 2D design often lack the ability to fully visualize and understand the spatial relationships of a design. For example, it is impossible to view the objects that may be located within a visually obstructed area, such as terrain, buildings, or other structures that block the line of sight. Furthermore, 2D drawings, such as floor plans and elevations, may not effectively communicate the designer's intent to the stakeholders such as clients, architects, and engineers. Thus, without a three-dimensional (3D) visualization, it can be challenging to convey the overall design concept and how different buildings, structures, and environmental assets relate to each other.

### SUMMARY

It is to be understood that both the following general description and the following detailed description are exemplary and explanatory only and are not restrictive. Methods, systems, and apparatuses for three-dimensional (3D) visualization of structures are described herein. For example, a computing device may receive first data indicative of a structure in a two-dimensional (2D) space. The first data may comprise floor plan information, dimension information, elevation information, structural element information, and material specification information. The computing device may receive second data indicative of one or more assets associated with a geolocation of the structure in a 3D representation of the Earth's surface. The one or more assets may comprise one or more terminal buildings, one or more runways, one or more taxiways, one or more aprons, one or more control towers, one or more hangars, and one or more cargo facilities. The second data may comprise geospatial data, survey data, structure data, and environment data associated with a predetermined area of the geolocation of the structure. The computing device may determine, based on the first data and the second data, a 3D model. The 3D model may comprise the structure and the one or more assets from a perspective of the structure. The structure and the one or more assets may be aligned to respective geolocation in the 3D representation of the Earth's space. The computing device may cause output of the 3D model in a 3D virtual space via a virtual reality platform of a user device. Based the 3D model and based on a request from the user device, the computing device may update one or more features associated with the structure. The one or more features associated with the structure may comprise one or more of a plane feature, a tower feature, a cabinetry feature, a weather feature, or a site feature.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the methods and systems described herein. To easily identify the discussion of any particular element or act, the most significant digit or digits in a reference number may refer to the figure number in which that element is first introduced.

FIG. 1 shows an example communication system;

FIG. 2 shows an example system;

FIG. 3 shows an example method;

FIG. 4A shows an example method;

FIG. 4B shows an example diagram;

FIG. 5A shows an example method;

FIG. 5B shows an example diagram;

FIG. 6A shows an example method;

FIG. 6B shows an example diagram;

FIG. 7A shows an example method;

FIG. 7B shows an example diagram;

FIG. 8A shows an example method;

FIG. 8B shows an example diagram;

FIG. 9 shows an example diagram; and

FIG. 10 shows an example computing device.

### DETAILED DESCRIPTION

As used in the specification and the appended claims, the singular forms “a,” “an,” and “the” include plural referents unless the context clearly dictates otherwise.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Various embodiments of the present disclosure are directed to three-dimensional (3D) visualization of structures. People have traditionally relied on two-dimensional (2D) representations to visualize architectural structures. For instance, architects would rely on two-dimensional floor plans, elevation plans, and other schematic designs. While these 2D designs may offer insights into the layout and dimensions of a structure, 2D designs often fail to provide a complete representation of spatial relationships and real-world positioning. Such limitations are particularly evident in complex environments, like airport control towers and transportation hubs, where the integration of multiple assets and precise geolocation information is critical. Furthermore, traditional 3D modeling often lacks real-time interaction capabilities.

Various embodiments of the present disclosure addresses these challenges by introducing a system and method that convert 2D designs into detailed 3D models, which are seamlessly integrated with geospatial data for accurate real-world positioning. Utilizing sophisticated gaming engines and geo-referencing techniques, the invention enables the creation of highly detailed 3D models that accurately represent structures and their associated assets in a virtual environment. By incorporating geospatial data, the system ensures that these models are aligned with their actual geographic coordinates on the Earth's surface, facilitating an enhanced understanding of spatial dynamics. Users can interact with these models in real-time through virtual reality platforms, allowing for dynamic updates to features, such as weather conditions, asset visibility, and structural positioning.

Moreover, the invention empowers users with immersive and collaborative interaction capabilities, transforming how architectural designs are visualized and manipulated. Through virtual reality headsets, users can experience a fully immersive environment, enhancing engagement and understanding of complex spatial arrangements. The system supports real-time collaboration, enabling multiple users to simultaneously view and modify the same 3D model, which is particularly beneficial in planning, training, and operational contexts. By solving the limitations of traditional 2D visualization and integrating advanced technologies, this invention not only enhances the fidelity of architectural models but also significantly improves decision-making processes and collaborative efforts in projects involving complex environments.

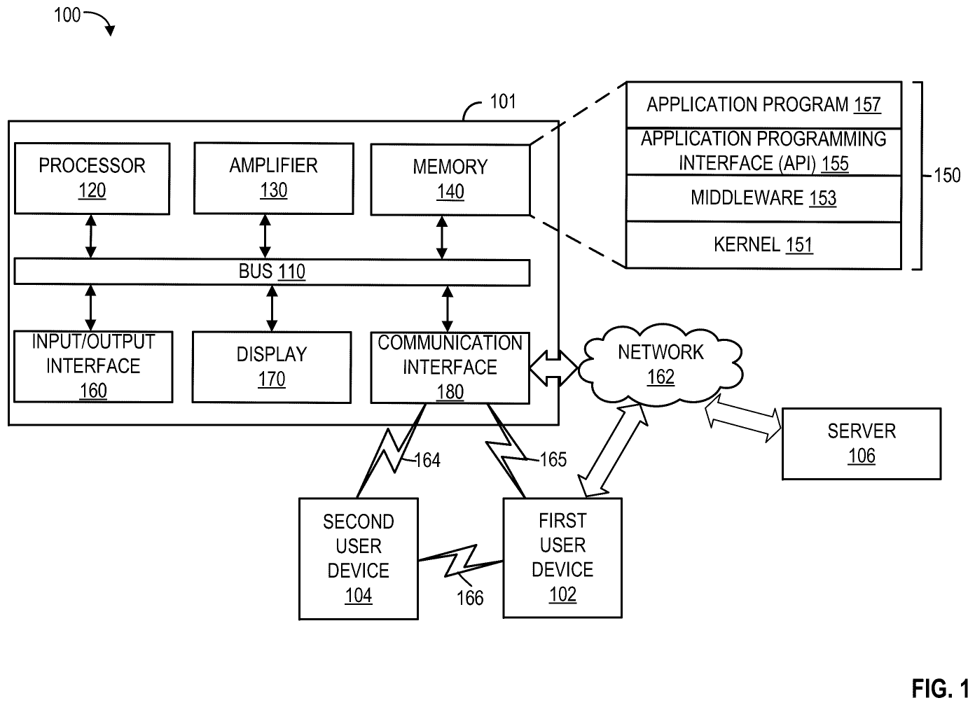

FIG. 1 shows an example communication system 100, where the methods, apparatuses, and systems described herein may be implemented according to various examples. Referring to FIG. 1, a computing device 101 in the communication system 100 is disclosed according to various examples. The computing device 101 may include a bus 110, a processor 120, an amplifier 130, a memory 140, an input/output interface 160, a display 170, and a communication interface 180. In a certain example, the computing device 101 may omit at least one of the aforementioned elements or may additionally include other elements. The computing device 101 may comprise a microcomputer, a miniature computer, a single board computer, a microcontroller, or a circuit board. For example, the computing device 101 may be a mobile phone, a smart phone, a tablet computer, a laptop computer, a desktop computer, a smartwatch, and the like.

The computing device 101 may be configured to process the signals or data received from other devices such as a first user device 102, a second user device 104, and/or a sever 106. The computing device 101 may receive the signals or data using a wireless connection or a wired connection. For example, the computing device 101 may forward the signals or data to the first user device 102, the second user device 104, and/or the sever 106 for further processing. The first user device 102, the second user device 104, and/or the sever 106 may process the signals or data and transmit the processed data to the computing device 101.

The bus 110 may include a circuit for connecting the aforementioned elements 110 to 180 to each other and for delivering communication (e.g., a control message and/or data) between the aforementioned elements 110 to 180. For instance, the bus 110 may be designed to send the signals or data from the processor 120 to the communication interface 180 in order to further transmit the signals or data to an external device, such as the electronic device and/or a server 106.

The processor 120 may include one or more of a Microcontroller Unit (MCU), a Central Processing Unit (CPU), an Application Processor (AP), or a Communication Processor (CP). The processor 120 may control, for example, at least one of the other elements of the computing device 101 and/or may execute arithmetic operations or data processing for communication. The processing (or controlling) operation of the processor 120, according to various examples, is described in detail with reference to the following figures. The processor 120 may include an on-chip analog-to-digital converter (ADC) for converting the amplified voltage signal, received from the amplifier 130 (described below), from an analog signal to a digital signal. The processor 120 may be used to process the data (e.g., data indicative of a structure in a 2D space and/or data indicative of one or more assets associated with the geolocation of the structure in a 3D representation of the Earth's surface) received from the first user device 102, the second user device 104, and/or the sever 106. The processor 120 may then send the processed data (e.g., a 3D model) to the communication interface 180 (e.g., a Bluetooth module, a cellular module, a Wi-Fi module, a Zigbee module, an NFC module, or any other short/long range communication module) using a Universal Asynchronous Receiver/Transmitter (UART), wherein the communication interface 180 may further transmit the data to an external electronic device such as the first user device 102, the second user device 104, and/or the sever 106.

The processor 120 may receive first data indicative of a structure or a building in a 2D space. The structure or building may be an airport control tower, a transportation hub, a college building, a military base, a museum, or a structure in a park. The structure or building in the 2D space may be designed by various software programs such as AutoCAD®, SketchUp®, Revit®, Vectorworks®, BricsCAD®, DraftSight®, and/or the like. The first data may be related to the design of the structure or building in a 2D space. The first data may include information to convert the 2D design of the structure or building to a 3D model. For example, the first data may comprise floor plan information, dimension information, elevation information, structural element information, and material specification information. The first data may be received from the first user device 102, the second user device 104, the server 106, and/or any devices that can perform software programs to design the structure or building in a 2D space. The processor 120 may generate the first data using an application program 157 (e.g., software program to design a structure or building in a 2D space) and locally save in the storage (e.g., memory 140, hard disk, and/or database) associated with the computing device 101.

The processor 120 may receive second data indicative of one or more assets. The one or more assets may be associated with a geolocation of the structure or building in a 3D representation of the Earth's surface. For example, the one or more assets may be tied to specific geographic coordinates on the Earth's surface with latitude, longitude, and/or altitude information. The one or more assets may be associated with an airport and its surrounding facilities. For example, the one or more assets may comprise one or more terminal buildings, one or more runways, one or more taxiways, one or more aprons, one or more control towers, one or more hangars, and one or more cargo facilities. The second data may include information to convert the one or more assets and surrounding environments to a 3D model. For example, the second data may comprise geospatial data, survey data, structure data, and environment data associated with a predetermined area of the geolocation of the structure or building.

The second data may be obtained based on a virtual globe, map, and geographical program such as the Google® Earth API, Google® Earth Studio, and/or Google® Earth Engine. Similar to the first data, the second data may be received from the first user device 102, the second user device 104, the server 106, and/or any devices that can perform the virtual globe, map, and geographical program for a 3D representation of the Earth's surface. The processor 120 may generate the second data using the application program 157 (e.g., a virtual globe, map, and geographical program for a 3D representation of the Earth's surface) and locally save the second data in the storage (e.g., memory 140, hard disk, and/or database) associated with the computing device 101.

The processor 120 may determine the 3D model comprising the structure and the one or more assets based on the first data and the second data. For example, the processor 120 may use gaming engines such as Unreal® and Unity® to generate the 3D model. The gaming engines may import the first data and the second data and create virtual environments based on real-world locations. The processor 120 may use geo-referencing or geo-mapping techniques to generate the 3D model. The 3D model comprising the structure and the one or more assets may be viewed from the perspective of the structure or building in a 3D virtual space via a virtual reality platform of the first user device 102 and/or the second user device 104. The structure and the one or more assets may align to respective geolocation in the 3D representation of the Earth's space.

The processor 120 may cause the output of the 3D model in a 3D virtual space via the first user device 102 and/or the second user device 104. For example, the output of the 3D model may be displayed via a virtual reality platform of the first user device 102, and/or the second user device 104. The virtual reality platform of the user devices 102, 104 may be a virtual reality headset designed for immersive virtual reality experiences. The processor 120 may update one or more features associated with the 3D model. For example, the processor 120 may update the one or more features associated with the structure (or building), the one or more assets, and surrounding environments based on the 3D model and based on a request from the first user device 102, and/or the second user device 104. The one or more features associated with the structure (or building), the one or more assets, and surrounding environments may be related to an airport and its surrounding facilities. For example, the one or more features may comprise one or more of a plane feature, a tower feature, a cabinetry feature, a control feature, a weather feature, or a site feature. The processor may update the one or more features in real-time while a user wearing the user device 102, 104 (e.g., a virtual reality headset) navigates menus in the 3D model in the 3D virtual space and selects one or more features to update.

The amplifier 130 may include an instrumentation amplifier, such as a MAX4208. An amplifier 130 may be used to amplify the signal or signals received from the first user device 102, the second user device 104, and/or the server 106. The output signal may be amplified using the amplifier 130 in order to obtain optimal results from the ADC.

The memory 140 may include volatile and/or non-volatile memory. The memory 140 may store, for example, a command or data related to at least one different element of the computing device 101. According to various examples, the memory 140 may store a software and/or a program 150. The program 150 may include, for example, a kernel 151, a middleware 153, an Application Programming Interface (API) 155, and/or an application program (or an “application”) 157, or the like, configured for controlling one or more functions of the computing device 101 and/or an external device. At least one part of the kernel 151, middleware 153, or API 155 may be referred to as an Operating System (OS). The memory 140 may include a computer-readable recording medium having a program recorded therein to perform the method according to various examples by the processor 120.

The kernel 151 may control or manage, for example, system resources (e.g., the bus 110, the processor 120, the memory 140, etc.) used to execute an operation or function implemented in other programs (e.g., the middleware 153, the API 155, or the application program 157). Further, the kernel 151 may provide an interface capable of controlling or managing the system resources by accessing individual elements of the computing device 101 in the middleware 153, the API 155, or the application program 157.

The middleware 153 may perform, for example, a mediation role so that the API 155 or the application program 157 can communicate with the kernel 151 to exchange data.

Further, the middleware 153 may handle one or more task requests received from the application program 157 according to a priority. For example, the middleware 153 may assign a priority of using the system resources (e.g., the bus 110, the processor 120, or the memory 140) of the computing device 101 to at least one of the application programs 157. For instance, the middleware 153 may process the one or more task requests according to the priority assigned to at least one of the application programs, and thus, may perform scheduling or load balancing on the one or more task requests.

The API 155 may include at least one interface or function (e.g., an instruction), for example, for file control, window control, video processing, or character control, as an interface capable of controlling a function provided by the application program 157 in the kernel 151 or the middleware 153.

For example, the input/output interface 160 may play a role of an interface for delivering an instruction or data input from a user or a different external device(s) to the different elements of the computing device 101. Further, the input/output interface 160 may output an instruction or data received from the different element(s) of the computing device 101 to the different external device.

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body.

The communication interface 180 may establish, for example, communication between the computing device 101 and an external device (e.g., the user devices 102, 104, a server 106, or the like). In one example, the communication interface 180 may communicate with the first user device 102 and/or the second user device 104 through wireless communication or wired communication. In one example, the communication interface 180 may communicate with an external device (e.g., the server 106) by being connected to a network 162 through wireless communication or wired communication.

In another example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication 164-166. The near-distance communications 164-166 may include, for example, at least one of Bluetooth, Wireless Fidelity (WiFi), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication interface may include, for example, at least one of Universal Serial Bus (USB), High-Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

The first user device 102 and/or the second user device 104 may a virtual reality headset designed for immersive virtual reality experiences for users. The first user device 102 and/or the second user device 104 may comprise a virtual reality platform (e.g., software and/or hardware) that enables users to experience and interact with virtual environments. The first user device 102 and/or the second user device 104 may include a built-in display (now shown) and motion tracking sensors (not shown) to provide users with a fully immersive experience. Examples of the virtual reality platform of the first user device 102 and/or the second user device 104 may include, but are not limited to, Oculus® Rift, HTC® Vive, PlayStation® VR, Valve® Index, Meta® Quest®, and Apple® Vision Pro®.

The first user device 102 and/or the second user device 104 may be operated by a user with a headset controller (not shown), a handheld controller (not shown), or an external input device (not shown). For example, the first user device 102 and/or the second user device 104 may communicate with the handheld controller or the external input device via a wireless or wired connection. The headset controller may include buttons or touch-sensitive surfaces directly on the virtual reality headset. The headset controller may allow a user to perform actions such as navigating menus, selecting options, and/or adjusting settings. The handheld controller may include buttons, triggers, and/or thumb sticks. The handheld controller may also allow a user to perform actions such as navigating menus, selecting options, and/or adjusting settings. The external input device may include a keyboard, mice, and/or a gamepad. The external input device may also allow a user to perform actions such as navigating menus, selecting options, and/or adjusting settings.

The first user device 102 and/or the second user device 104 may comprise a communication interface (not shown) that can establish, for example, communication between the computing device 101 and the user device 102, 104, between the server 106 and the user device 102, 104, and/or between the first user device 102 and the second user device 104. For example, the first user device 102 and/or the second user device 104 may communicate with other devices through wireless communication or wired communication. In one example, the communication interface of the first user device 102 and/or the second user device 104 may communicate with an external device (e.g., the server 106) by being connected to a network 162 through wireless communication or wired communication. In another example, the communication interface of the first user device 102 and/or the second user device 104 may communicate with the computing device 101 through wireless communication or wired communication. In another example, the communication interface of the first user device 102 may directly communicate with the second user device 104 through wireless communication. In another example, the communication interface of the first user device 102 may communicate with the second user device 104 by being connected to the network 162 and/or the computing device 101 through wireless communication. For example, a user wearing the first user device 102 may navigate menus and select one or more features to update in the same 3D model in the 3D virtual space with another user wearing the second user device 104 via the wireless connection. The changes made by each user may be updated in real-time on both the first user device 102 and the second user device 104.

The communication interface of the first user device 102 and/or the second user device 104 may use the wireless communication such as Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication of the first user device 102 and/or the second user device 104 may include, for example, a near-distance communication 164-166. The near-distance communications 164-166 may include, for example, at least one of Bluetooth, Wireless Fidelity (WiFi), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication interface of the first user device 102 and/or the second user device 104 may include, for example, at least one of Universal Serial Bus (USB), High Definition Multimedia Interface (HDMI), Recommended Standard-232 (RS-232), power-line communication, Plain Old Telephone Service (POTS), and the like.

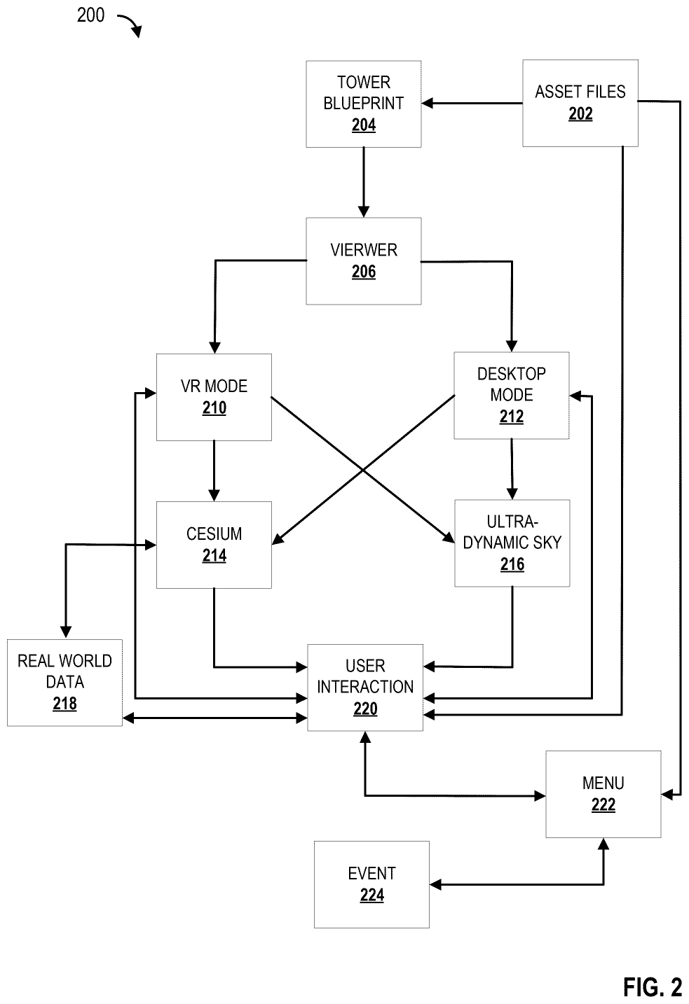

FIG. 2 shows an example system 200 for 3D visualization of structures, where the methods, apparatuses, and systems described herein may be implemented according to various examples. Referring to FIG. 2, at 202, the computing device 101 may receive asset files that include resources to create a 3D model. The assets files may comprise Datasmith® files, FBX files, OBJ files, and images and materials files. The Datasmith® files may comprise a data preparation or import pipeline toolset or Datasmith® plugin that allows for files to be brought into a gaming engine to convert 2D drawings to 3D models. The FBX files, OBJ files, and image and material files may represent objects, characters, environments, or other elements of a 3D model. These files may be brought into the gaming engine to create a 3D model. At 204, the computing device 101 may generate an airport tower blueprint. The airport tower blueprint may be constructed based on the asset files. At 206, the computing device 101 may generate a collaborative viewer that may show the airport tower in a 3D space. A user may start a VR mode at 210 or a desktop mode at 212. For example, the computing device 101 may receive user input indicating that the user wants to enter the program in the VR mode or the desktop mode.

At 214, the computing device 101 may use a Cesium plugin, a platform for creating 3D gloves and maps, to generate a 3D model (or 3D visualization) of the airport control tower and surrounding environments based on the tower blueprint and real-world data received or generated at 218. For example, the location of the airport control tower may be referenced from Cesium with 3D tiles accessed. Cesium may visualize and interact with the real-world data related to the location of the airport control tower and generate the 3D model of the airport control tower and surrounding environments. At 216, the computing device 101 may also use an ultra-dynamic sky plugin to provide realistic weather elements and sun positioning. For example, the ultra-dynamic sky plugin may provide the 3D model of the weather elements (or effects) such as cloud coverage, fog, rain, snow, sand/dust, wind intensity, and thunder/lighting. At 220, a user wearing the user device 102, 104 may interact with the 3D model of the airport control tower and surrounding environments in a 3D virtual space via a virtual reality platform of the user device 102, 104. The user's interaction with the 3D model may be recorded by the user device 102, 104. Alternatively, or additionally, the user's interaction with the 3D model may be transmitted to the computing device 101 via a wireless connection or wired connection, and the computing device 101 may record the user interaction with the 3D model for further processing. The user may freely switch between the VR mode and the desktop mode while using the virtual reality platform of the user device 102, 104.

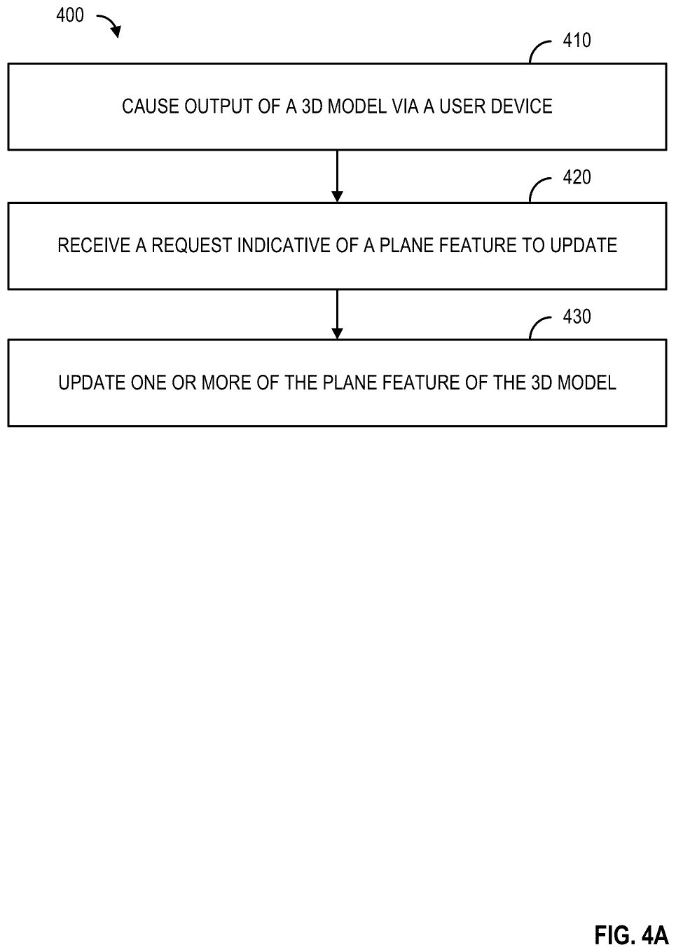

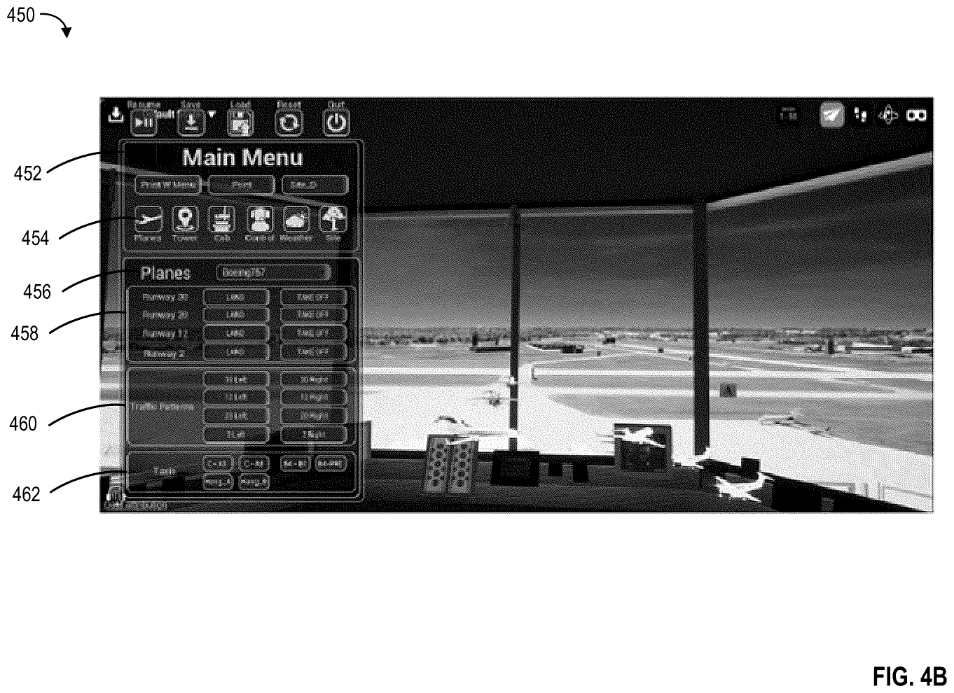

At 222, the user may open a menu to interact with the 3D model of the airport control tower and surrounding environments in the 3D virtual space. For example, the menu may allow the user to update one or more features associated with the 3D model. The menu may include a plane button, a tower button, a cabinetry button, a weather button, or a site button, as described in FIGS. 4-8. Each button may be used to update one or more features associated with the 3D model. For example, the plane button may be used to update the plane feature of the 3D model such as a plane identity, a runway, a traffic pattern, and/or a taxiway. The tower button may be used to update the tower feature of the 3D model such as a latitude, a longitude, an elevation, a height, a rotation, and/or a position associated with the airport control tower. The cabinetry button may be used to update the cabinetry feature of the 3D model (e.g., interior within the airport control tower) such as windows, staircases, and/or casework. The weather button may be used to update the weather feature of the 3D model such as a date, a time, a location, a time zone, cloud coverage, fog, rain, snow, sand/dust, wind intensity, and thunder/lightning. The site button may be used to update the site feature of the 3D model such as runway markers, taxiway markers, runway lights, and/or trees.

At 224, once the user selects or determines the one or more features to update, the user device 102, 104 may trigger an event to change the tower aesthetics, air traffic controller positions, weather and time of day, plane movements, visibility of structures, tower positions, and real-world positioning data. For example, the user device 102, 104 may send a request that comprises the user's selection information to update the one or more features of the 3D model. For example, to update the plane feature, the request may comprise a plane identity, a runway, a traffic pattern, and/or a taxiway. For the tower feature update, the request may comprise a latitude, a longitude, an elevation, a height, a rotation, and/or a position. For the cabinetry feature update, the request may comprise a window setting, a staircase setting, and/or a casework setting. For the weather feature update, the request may comprise a date, a time, a location, a time zone, cloud coverage, fog, rain, snow, sand/dust, wind intensity, and/or thunder/lighting. For the site feature update, the request may comprise site visibility, runway marker visibility, taxiway marker visibility, runway light visibility, and/or tree visibility.

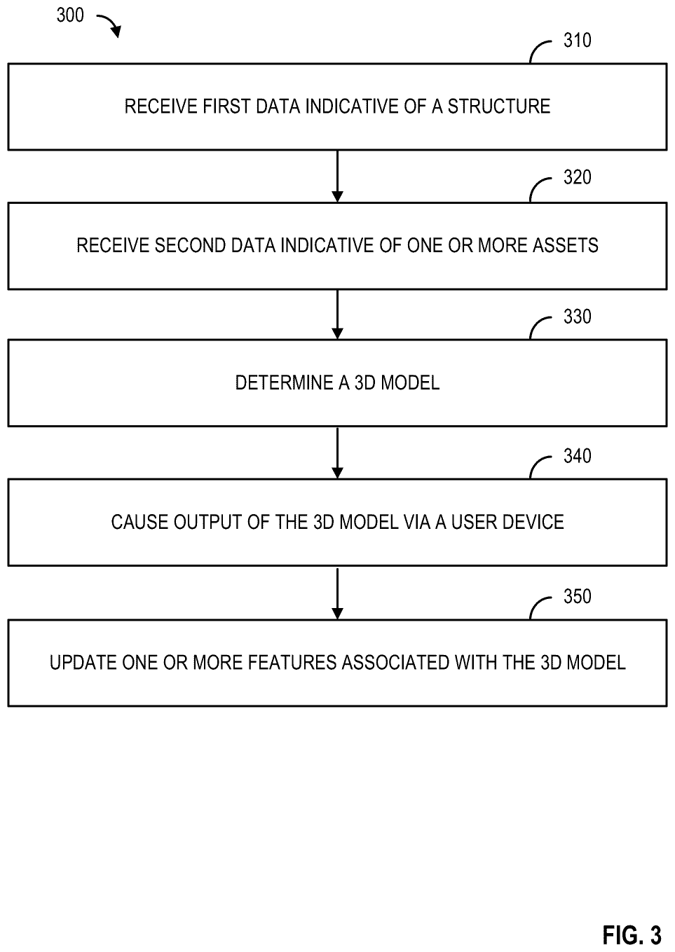

FIG. 3 shows an example method 300 for 3D visualization of structures. The method 300 may be performed by any device such as the computing device 101, the user devices 102, 104, and/or the server 106. At 310, first data indicative of a structure in a 2D space may be received. For example, the computing device 101 may receive the first data indicative of a structure or a building in a 2D space. The structure or building may be an airport control tower, a transportation hub, a college building, a military base, a museum, or a structure in a park. The structure or building in the 2D space may be designed by various software programs such as AutoCAD®, SketchUp®, Revit®, Vectorworks®, BricsCAD®, DraftSight®, and/or the like. The first data may be related to the design of the structure or building in a 2D space. The first data may include information to convert the 2D design of the structure or building to a 3D model. For example, the first data may comprise floor plan information, dimension information, elevation information, structural element information, and material specification information.

The floor plan information may comprise the layout of the structure's or building's floors, including the arrangement of rooms, walls, doors, windows, and other architectural elements. The dimension information may comprise the size and proportions of rooms and spaces within the structure or building. For example, the dimension information may include measurements of room sizes, wall lengths, door and window openings, ceiling heights, and other relevant dimensions. The elevation information may comprise vertical dimensions and features of the structure or building. For example, the elevation information may include wall heights, floor levels, roof slopes, and architectural details that are not visible in the floor plan. The material specification information may comprise information about the materials used for various components of the structure or building, such as walls, floors, ceilings, and finishes. The material specification information may be used to represent the appearance and texture of the various components of the structure or building.

It is noted that the first data may be received from the server 106, the user devices 102, 104, and/or any devices that can perform software programs to design the structure or building in a 2D space. The first data may be generated by the computing device 101 and locally saved in the computing device 101.

At 320, second data indicative of one or more assets may be received. For example, the computing device 101 may receive the second data indicative of one or more assets. The one or more assets may be associated with a geolocation of the structure or building in a 3D representation of the Earth's surface. For example, the one or more assets may be tied to specific geographic coordinates on the Earth's surface with latitude, longitude, and/or altitude information. The one or more assets may be associated with an airport and its surrounding facilities. For example, the one or more assets may comprise one or more terminal buildings, one or more runways, one or more taxiways, one or more aprons, one or more control towers, one or more hangars, and one or more cargo facilities.

The second data may include information to convert the one or more assets and surrounding environments to a 3D model. For example, the second data may comprise geospatial data, survey data, structure data, and environment data associated with a predetermined area of the geolocation of the structure or building. The geospatial data may comprise aerial imagery, satellite imagery, Light Detection and Ranging (LiDAR) data, and/or drone imagery. The geospatial data may provide detailed visual information about the terrain, vegetation, structures, buildings, and other features of the area. The survey data may comprise ground surveys, GPS surveys, and/or land surveys. The survey data may provide accurate measurements and dimensions of structures, terrain, and other physical features. The structure data may comprise architectural drawings, building plans, blueprints, and/or CAD files of structures within the area. The structure data may provide detailed information about the layout, dimensions, materials, and architectural features of structures or buildings. The environmental data may comprise terrain elevation, slope, vegetation coverage, land use, land cover information, hydrological features (e.g., rivers, lakes), and/or climatic conditions. The environmental data may provide the natural environment and landscape features of the area.

The second data may be obtained based on a virtual globe, map, and geographical program such as the Google® Earth API, Google® Earth Studio, and/or Google® Earth Engine. Similar to the first data, the second data may be received from the server 106, the user devices 102, 104, and/or any devices that can perform the virtual globe, map, and geographical program for a 3D representation of the Earth's surface. The first data may be generated by the computing device 101 and locally saved in the computing device 101.

At 330, a 3D model comprising the structure and the one or more assets may be determined. For example, the computing device 101 may determine the 3D model comprising the structure and the one or more assets based on the first data and the second data. For example, the computing device 101 may use gaming engines such as Unreal® and Unity® to generate the 3D model. The gaming engines may import the first data and the second data and create virtual environments based on real-world locations. The computing device 101 may use geo-referencing or geo-mapping techniques to generate the 3D model. The 3D model comprising the structure and the one or more assets may be viewed from a perspective of the structure or building in a 3D virtual space via a virtual reality platform of the user device 102, 104. The structure and the one or more assets may align to respective geolocation in the 3D representation of the Earth's space.

At 340, the output of the 3D model may be caused. For example, the computing device 101 may cause the output of the 3D model in a 3D virtual space via the user device 102, 104. For example, the output of the 3D model may be caused via a virtual reality platform of the user device 102, 104. The virtual reality platform of the user device 102, 104 may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller or an external input device. For example, the user device 102, 104 may communicate with the handheld controller or the external input device via a wireless or wired connection. The headset controller may include buttons or touch-sensitive surfaces directly on the virtual reality headset. The headset controller may allow a user to perform actions such as navigating menus, selecting options, and/or adjusting settings. The handheld controller may include buttons, triggers, and/or thumb sticks. The handheld controller may also allow a user to perform actions such as navigating menus, selecting options, and/or adjusting settings. The external input device may include a keyboard, mice, and/or a gamepad. The external input device may also allow a user to perform actions such as navigating menus, selecting options, and/or adjusting settings.

In at least some embodiments, the 3D model may be used to aid builders in building the structure. The 3D model may serve as a tool for builders and construction teams by providing a comprehensive and accurate visualization of the structure in its intended environment. By converting conventional 2D plans into a 3D representation, builders can better understand spatial relationships, such as the interaction between various structural elements and their placement within the site. The integration of geospatial data within the 3D model reflects the actual geographic coordinates of the structure, aiding in precise planning and execution of construction activities. Builders can use the 3D model to identify potential design conflicts, optimize resource allocation, and sequence construction tasks effectively. Moreover, the 3D visualization facilitates improved communication among stakeholders-architects, engineers, and clients-ensuring that the design intent is accurately conveyed and understood. The ability to interact with the model in real time allows builders to assess different construction scenarios, make informed decisions regarding material and labor deployment, and implement updates seamlessly as the project evolves. The 3D model acts as a dynamic blueprint that enhances efficiency, accuracy, and collaboration throughout the construction process.

At 350, one or more features associated with the 3D model may be updated. For example, the computing device 101 may update the one or more features associated with the structure. For example, the computing device 101 may update the one or more features associated with the structure (or building), the one or more assets, and surrounding environments based on the 3D model and based on a request from the user device 102, 104. The one or more features associated with the structure (or building), the one or more assets, and surrounding environments may be related to an airport and its surrounding facilities. For example, the one or more features may comprise one or more of a plane feature, a tower feature, a cabinetry feature, a control feature, a weather feature, or a site feature. The plane feature may comprise one or more plane identities, one or more runways, one or more traffic patterns, and/or one or more taxiways. The tower feature may comprise a latitude, a longitude, an elevation, a height, a rotation, and/or a position associated with the structure. The cabinetry feature may comprise one or more window settings, one or more staircase settings, and/or one or more casework settings. The weather feature may comprise a date, a time, a location, a time zone, cloud coverage, fog, rain, snow, sand/dust, wind intensity, and thunder/lightning. The site feature may comprise runway marker visibility, taxiway marker visibility, runway light visibility, and tree visibility.

The update of the one or more features may be performed in real-time. For example, a user wearing the user device 102, 104 (e.g., a virtual reality headset) may navigate menus in the 3D model in the 3D virtual space and select an option to update one of the features using a controller (e.g., the handheld controller). The computing device 101 may receive the request to update the feature and update the 3D model in real-time based on the 3D model and the request. Examples of updating one or more features are further described in FIGS. 4-8. It is also noted that one or more features associated with the one or more assets may be updated based on the 3D model and based on a request from the user device 102, 104.

FIG. 4A shows an example method 400 to update one or more features associated with a 3D model. FIG. 4B shows an example user interface 450 to update one or more of the plane feature of the 3D model. The method 400 may be performed by any device, such as the computing device 101, the user devices 102, 104, and/or the server 106. At 410, output of the 3D model may be caused. For example, the output of the 3D model may be caused via a virtual reality platform of the user device 102, 104. As shown in FIG. 4B, the output of the 3D model may be viewed from the perspective of an airport control tower. The virtual reality platform may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller, or an external input device.

At 420, a request indicative of a plane feature to update may be received. For example, the computing device 101 may receive the request indicative of the plane feature to update from the user device 102, 104. For example, the plane feature may comprise one or more plane identities, one or more runways, one or more traffic patterns, and one or more taxiways. The request may comprise a plane identity of the one or more plane identities, a runway of the one or more runways, a traffic pattern of the one or more traffic patterns, or a taxiway of the one or more taxiways. For example, as shown in FIG. 4B, a user wearing the user device 102, 104 (e.g., a virtual reality headset) may navigate a main menu 452 of the 3D model in the 3D virtual space and select a plane button 454 to update one or more features associated with the plane feature, using a controller (e.g., the handheld controller). The user may select a plane (e.g., Boeing 767) in the planes tab 456. The user may select a runway in the runway tab 458 for the selected plane. For example, the user may select runway 12 for landing and runway 30 for taking off for the selected plane. The user may select a traffic pattern in the traffic pattern tab 460 for the selected plane. For example, the user may determine the preferred direction for the selected plane to operate in the traffic pattern. For example, the user may select 30 left to indicate that the preferred traffic pattern direction is counterclockwise or left traffic. The user may select 30 right to indicate that the preferred traffic pattern direction is clockwise or right traffic. The user may select a taxiway in the taxis tab 462 for the selected plane. For example, the user may select C-A1 as a taxi route or pathway for the movement of the selected plane on the ground. Once the selection of the one or more features are completed, the user device 102, 104 may send the request indicative of the one or more selected features to the computing device 101.

At 430, one or more of the plane feature of the 3D model may be updated. For example, the computing device 101 may update the one or more of the plane feature of the 3D model. For example, the computing device 101 may update the one or more of the plane feature based on one or more of the plane identity, the runway, the traffic pattern, or the taxiway. The computing device 101 may simulate taxing, taking off, and/or landing for the selected plane based on the selected taxiway, runway, and traffic patterns via the virtual reality platform of the user device 102, 104. In an example, with 30 left as the selected traffic pattern, the selected plane may be simulated through the user device 102, 104 to make left turns during the circuit around the airport. In another example, with 30 right as the selected traffic pattern, the selected plane may be simulated through the user device 102, 104 to make right turns during the circuit around the airport. The user may visualize the movement/simulation of the selected plane with the selected taxiway, runway, and traffic pattern from the view of the airport control tower via the virtual reality platform of the user device 102, 104.

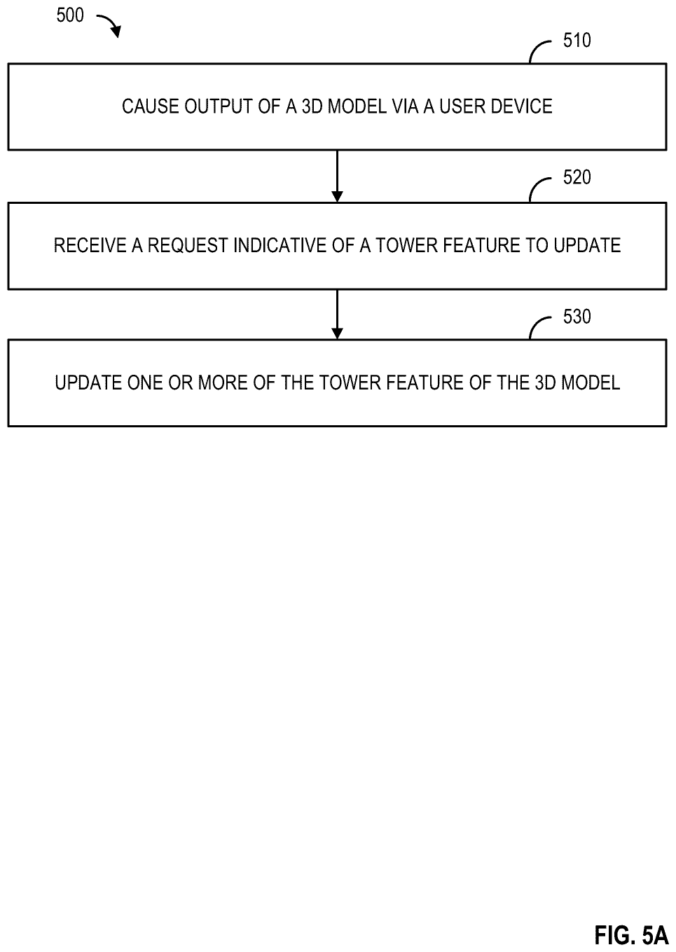

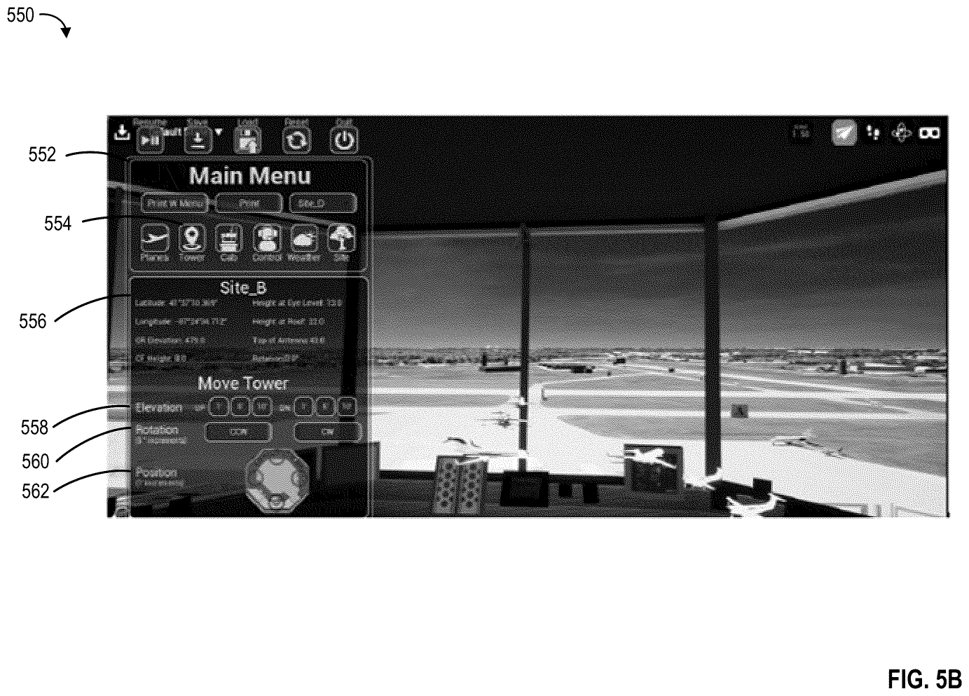

FIG. 5A shows an example method 500 to update one or more features associated with a 3D model. FIG. 5B shows an example user interface 550 to update one or more of the tower feature of the 3D model. The method 500 may be performed by any device, such as the computing device 101, the user devices 102, 104, and/or the server 106. At 510, the output of the 3D model may be caused. For example, the output of the 3D model may be caused via a virtual reality platform of the user device 102, 104. As shown in FIG. 5B, the output of the 3D model may be viewed from the perspective of an airport control tower. The virtual reality platform may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller, or an external input device.

At 520, a request indicative of a tower feature to update may be received. For example, the computing device 101 may receive the request indicative of the tower feature to update from the user device 102, 104. For example, the tower feature may comprise a latitude, a longitude, an elevation, a height, a rotation, and a position associated with the structure. The request may comprise a latitude, a longitude, an elevation, a height, a rotation, and a position associated with the structure. For example, as shown in FIG. 5B, a user wearing the user device 102, 104 (e.g., a virtual reality headset) may navigate a main menu 552 of the 3D model in the 3D virtual space and select a tower button 554 to update one or more features associated with the tower feature, using a controller (e.g., the handheld controller). The user may select a site (e.g., Site B) in the site tab 556. The site tab 556 may display the latitude, longitude, and height associated with the selected site. The user may select an elevation in the elevation tab 558 for the selected site. For example, the user may move the elevation of the tower (or the structure) by a specified distance. The user may select a rotation of the tower (or the structure) in the rotation tab 560 for the selected site. For example, the user may rotate the direction of the tower (or the structure) to the counterclockwise direction (e.g., CCW) or the clockwise direction (e.g., CW). The tower (or the structure) may be rotated by a predefined distance (e.g., 5 feet increment). The user may select a position of the tower (or the structure) in the position tab 562 for the selected site. For example, the user may move the position of the tower (or the structure) to the north, south, cast, or west direction. Alternatively or additionally, the user may move the position of the tower (or the structure) to the upward, downward, right, or left direction. The tower (or the structure) may be moved by a predefined distance (e.g., 1 foot increment).

At 530, one or more of the tower feature of the 3D model may be updated. For example, the computing device 101 may update the one or more of the tower feature of the 3D model. For example, the computing device 101 may update the one or more of the tower feature based on one or more of the selected site (e.g., the selected latitude, longitude, and height), the selected elevation, the selected rotation, or the selected position. For example, the tower (or the structure) in the selected site may be elevated up by 5 feet, rotated to counterclockwise by 10 feet, and moved to the north direction by 2 feet via the virtual reality platform of the user device 102, 104. The user may visualize the surroundings of the tower (or the structure) from the view of the elevated, rotated, and moved the position of the airport control tower via the virtual reality platform of the user device 102, 104.

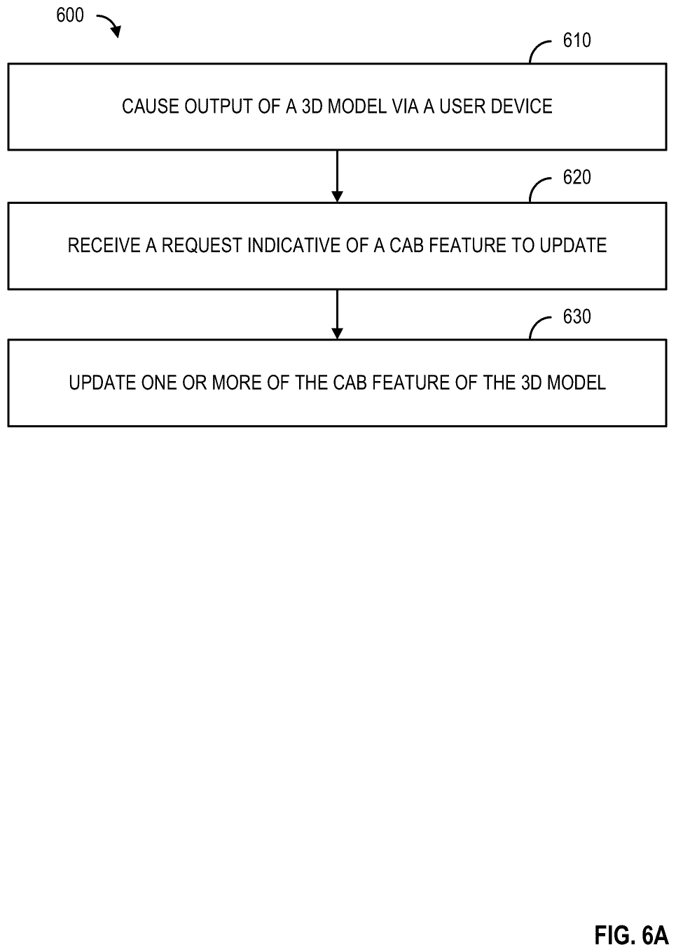

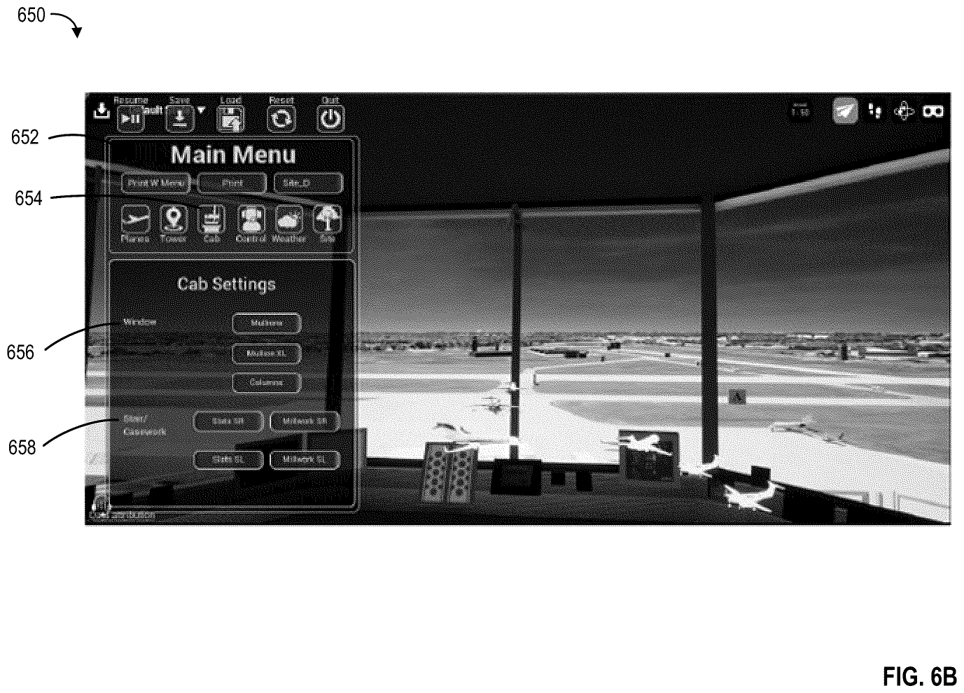

FIG. 6A shows an example method 600 to update one or more features associated with a 3D model. FIG. 6B shows an example user interface 650 to update one or more of the cabinetry feature of the 3D model. The method 600 may be performed by any device such as the computing device 101, the user devices 102, 104, and/or the server 106. At 610, the output of the 3D model may be caused. For example, the output of the 3D model may be caused via a virtual reality platform of the user device 102, 104. As shown in FIG. 6B, the output of the 3D model may be viewed from the perspective of an airport control tower. The virtual reality platform may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller, or an external input device.

At 620, a request indicative of a cabinetry (or cab) feature to update may be received. For example, the computing device 101 may receive the request indicative of the cab feature to update from the user device 102, 104. For example, the cab feature may comprise one or more window settings, one or more staircase settings, and one or more casework settings. The request may comprise a window setting of the one or more window settings, a staircase setting of the one or more staircase settings, and a casework setting of the one or more casework settings. For example, as shown in FIG. 6B, a user wearing the user device 102, 104 (e.g., a virtual reality headset) may navigate a main menu 652 of the 3D model in the 3D virtual space and select a cabinetry button 654 to update one or more features associated with the cabinetry feature, using a controller (e.g., the handheld controller). The user may select a window setting in the window setting tab 656. The window setting may include a number of mullions, a size of mullions, a number of columns, and/or a size of columns. For example, the user may select the number of mullions, the size of mullions, the number of columns, and/or the size of columns for the interior space of the airport control tower. The user may also select a stair/casework setting in the stair/casework setting tab 658. The stair/casework setting may include Slats SR, Slats SL, Millwork SR, Millwork SL. For example, the user may select Slats SR, Slats SL, Millwork SR, Millwork SL for the interior space of the airport control tower.

At 630, one or more of the cabinetry feature of the 3D model may be updated. For example, the computing device 101 may update the one or more of the cabinetry feature of the 3D model. For example, the computing device 101 may update the one or more of the cabinetry feature based on one or more of the selected widow setting, the selected staircase setting, or the selected casework setting. For example, the airport control tower (or the structure) in the 3D virtual space may include the number of mullions, the size of mullions, the number of columns, and/or the size of columns based on the user selected settings. The user may visualize the windows, stairs, and casework of the interior space of the airport control tower (or the structure) based on the output of the updated 3D model via the virtual reality platform of the user device 102, 104.

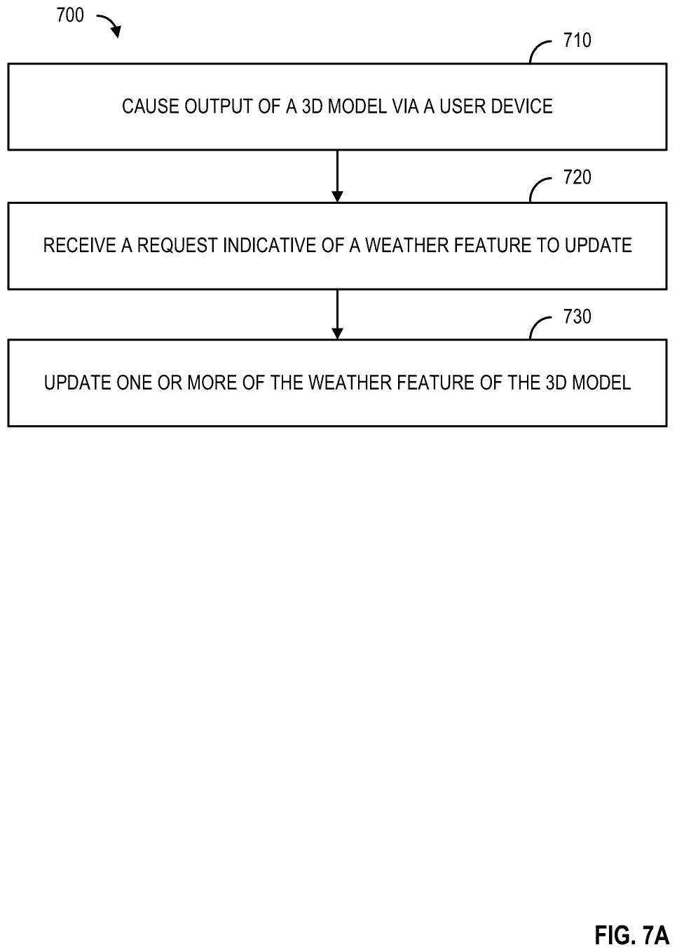

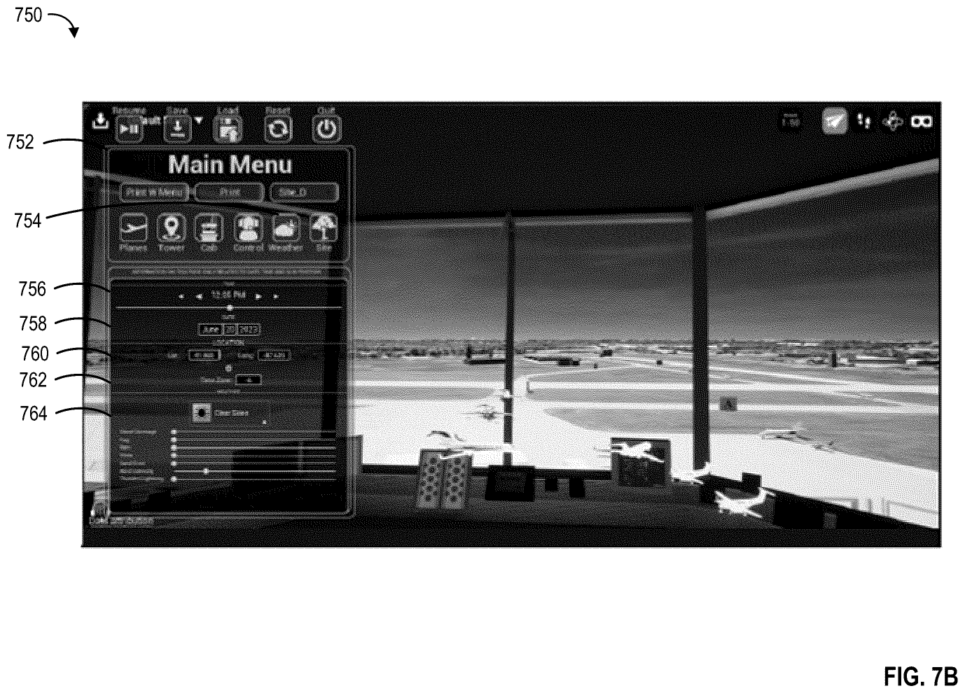

FIG. 7A shows an example method 700 to update one or more features associated with a 3D model. FIG. 7B shows an example user interface 750 to update one or more of a weather feature of the 3D model. The method 700 may be performed by any device, such as the computing device 101, the user devices 102, 104, and/or the server 106. At 710, the output of the 3D model may be caused. For example, the output of the 3D model may be caused via a virtual reality platform of the user device 102, 104. As shown in FIG. 7B, the output of the 3D model may be viewed from the perspective of an airport control tower. The virtual reality platform may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller, or an external input device.

At 720, a request indicative of a weather feature to update may be received. For example, the computing device 101 may receive the request indicative of the weather feature to update from the user device 102, 104. For example, the weather feature may comprise a date, a time, a location, a time zone, and weather elements such as cloud coverage, fog, rain, snow, sand/dust, wind intensity, and thunder/lightning. The request may comprise a date, a time, a location, a time zone, and weather element settings such as cloud coverage, fog, rain, snow, sand/dust, wind intensity, and thunder/lighting. For example, as shown in FIG. 7B, a user wearing the user device 102, 104 (e.g., a virtual reality headset) may navigate a main menu 752 of the 3D model in the 3D virtual space and select a weather button 754 to update one or more features associated with the weather feature, using a controller (e.g., the handheld controller). The user may determine the time in the time tab 756. The user may specify the date in the date tab 758. The user may determine the location based on the latitude and the longitude in the location tab 760. The user may determine the time zone in the time zone tab 762. The user may add one or more weather effects to the 3D model by adjusting the weather elements in the weather element tab 764. The weather elements may include cloud coverage, fog, rain, snow, sand/dust, wind intensity, and thunder/lighting. For example, the user may adjust the amount of cloud coverage, the thickness of fog, and the density of rain, snow, and sand/dust in the 3D model. The user may also adjust the intensity of wind in the 3D model. The user may add thunder and/or lighting effects to the 3D model.

At 730, one or more of the weather feature of the 3D model may be updated. For example, the computing device 101 may update the one or more of the weather feature of the 3D model. For example, the computing device 101 may update the one or more of the weather feature based on one or more of the selected date, the selected time, the selected location, the selected time zone, the adjusted amount of cloud coverage, the adjusted thickness of fog, the adjusted density of rain, the adjusted density of snow, the adjusted density of sand/dust, the adjusted wind intensity, or the thunder/lightning effects. The computing device 101 may simulate the 3D model based on the adjusted weather elements via the virtual reality platform of the user device 102, 104. The user may visualize the airport control tower and its surroundings with the weather effect updated based on the weather elements via the virtual reality platform of the user device 102, 104.

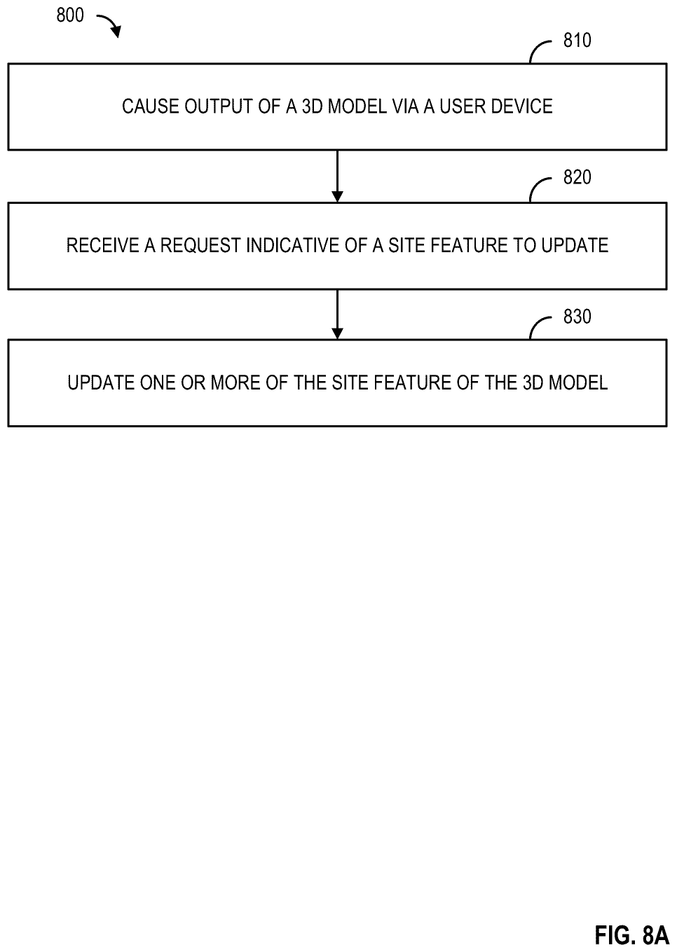

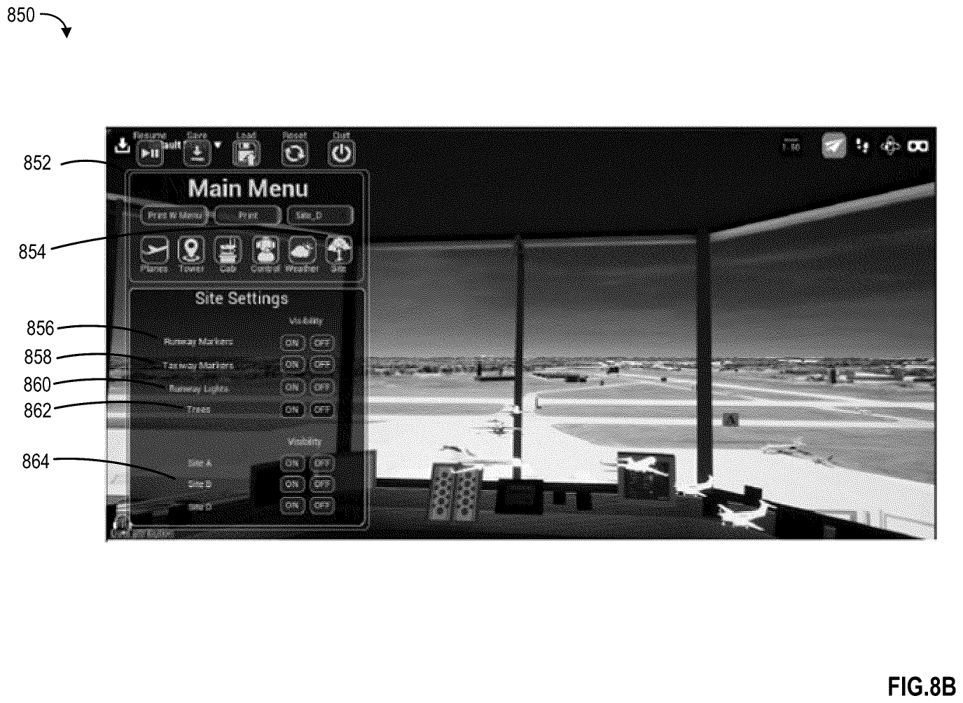

FIG. 8A shows an example method 500 to update one or more features associated with a 3D model. FIG. 8B shows an example user interface 850 to update one or more of a site feature of the 3D model. The method 800 may be performed by any device, such as the computing device 101, the user devices 102, 104, and/or the server 106. At 810, the output of the 3D model may be caused. For example, the output of the 3D model may be caused via a virtual reality platform of the user device 102, 104. As shown in FIG. 8B, the output of the 3D model may be viewed from the perspective of an airport control tower. The virtual reality platform may be a virtual reality headset designed for immersive virtual reality experiences. The virtual reality headset may include a built-in display and motion tracking sensors to provide users with a fully immersive experience. Examples of the virtual reality platform of the user device 102, 104 may include, but are not limited to, Oculus® Rift, HTC® Vive, PlayStation® VR, Valve® Index, Meta® Quest®, and Apple® Vision Pro®. The virtual reality platform of the user device 102, 104 may be operated by a user with a headset controller, a handheld controller, or an external input device.

At 820, a request indicative of a site feature to update may be received. For example, the computing device 101 may receive the request indicative of the site feature to update from the user device 102, 104. For example, the site feature may comprise site visibility, runway marker visibility, taxiway marker visibility, runway light visibility, and tree visibility. The request may comprise site visibility, runway marker visibility, taxiway marker visibility, runway light visibility, and tree visibility associated with a selected site (e.g., Site A). For example, as shown in FIG. 8B, a user wearing the user device 102, 104 (e.g., a virtual reality headset) may navigate a main menu 852 of the 3D model in the 3D virtual space, and select a site button 854 to update one or more features associated with the site feature, using a controller (e.g., the handheld controller). The user may select the site visibility of the 3D model in the site visibility tab 864. For example, the user may select site B to be visible or invisible on the 3D model by clicking on or off buttons. The user may select the runway marker visibility of the selected site in the runway markers tab 856. For example, the user may select runway marker visibility of the selected site to be visible or invisible on the runway of the selected site by clicking on or off buttons. The user may select the taxiway marker visibility of the selected site in the taxiway markers tab 858. For example, the user may select taxiway marker visibility of the selected site to be visible or invisible on the taxiway of the selected site by clicking on or off buttons. The user may select the runway light visibility of the selected site in the runway lights tab 860. For example, the user may select runway light visibility of the selected site to be visible or invisible on the runway of the selected site by clicking on or off buttons. The user may select the tree visibility of the selected site in the tree tab 862. For example, the user may select tree visibility of the selected site to be visible or invisible on the selected site by clicking on or off buttons.

At 830, one or more of the site feature of the 3D model may be updated. For example, the computing device 101 may update the one or more of the site feature of the 3D model. For example, the computing device 101 may update the one or more of the site feature based on one or more of the selected site visibility, the selected runway marker visibility, the selected taxiway marker visibility, the selected runway light visibility, or the selected tree visibility. For example, the selected site may or may not be viewed with runway markers, taxiway markers, runway lights, and/or trees via the virtual reality platform of the user device 102, 104. The user may visualize the selected sites and surroundings (e.g., runway markers, taxiway markers, runway lights, and/or trees) of the selected site from the view of the airport control tower via the virtual reality platform of the user device 102, 104.

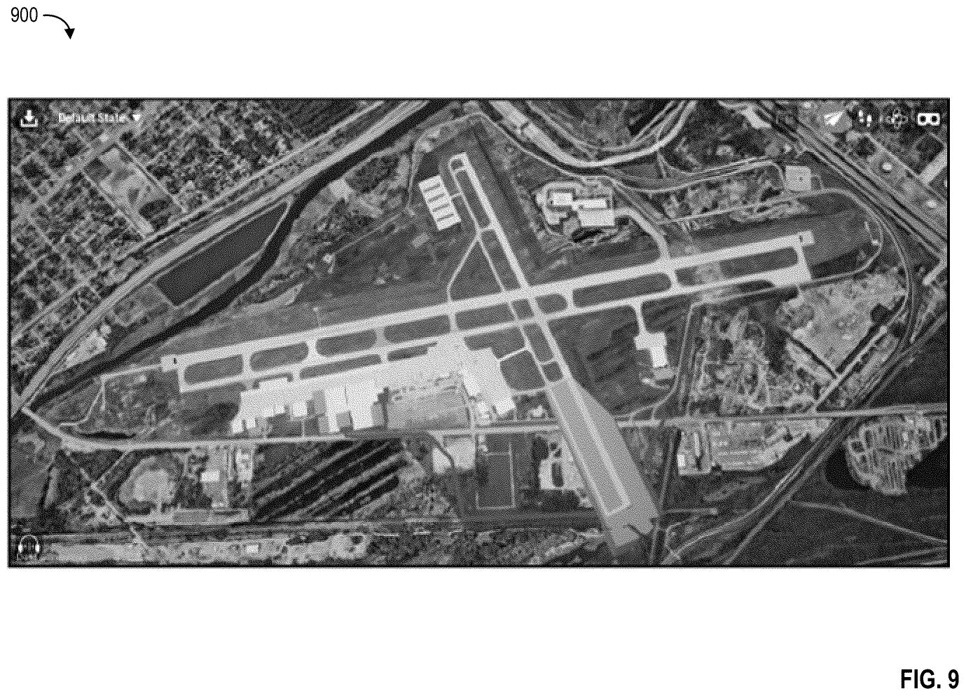

FIG. 9 shows an example aerial view of an airport 900 where one or more structures or buildings and one or more assets may be visualized in a 3D virtual space via a virtual reality platform of a user device 102, 104.

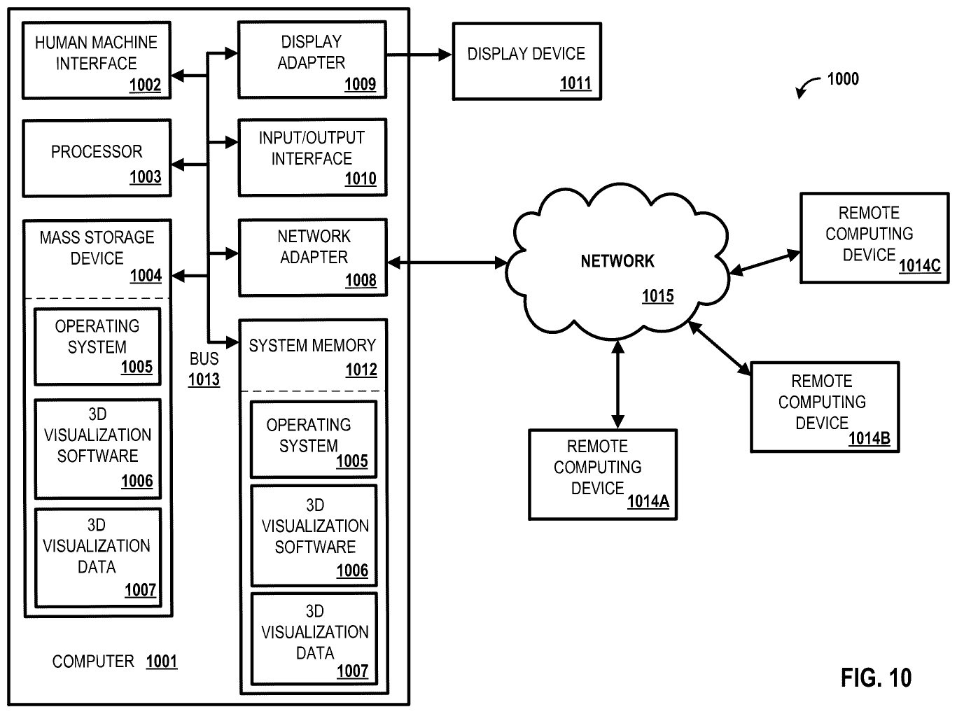

The methods described herein may be implemented on a computer 1001 as illustrated in FIG. 10 and described below. By way of example, the computing device 101, the user device 102, 104, and the server 106 of FIG. 1 may each be a computer 1001 as illustrated in FIG. 10. Similarly, the methods described herein may utilize one or more computers to perform one or more functions in one or more locations. FIG. 10 is a block diagram 1000 illustrating an operating environment for performing the described methods. This operating environment is only an example of an operating environment and is not intended to suggest any limitation as to the scope of use or functionality of operating environment architecture. Neither should the operating environment be interpreted as having any dependency or requirement relating to any one or combination of components illustrated in the operating environment.

The present methods for 3D visualization of structures may be operational with numerous other general purpose or special purpose computing system environments or configurations. Examples of well-known computing systems, environments, and/or configurations that may be suitable for use with the systems and methods may comprise, but are not limited to, network devices, security devices, personal computers, server computers, laptop devices, and multiprocessor systems. Additional examples may comprise programmable consumer electronics, network PCs, minicomputers, mainframe computers, distributed computing environments that comprise any of the above systems or devices, and the like.

The processing of the described methods may be performed by software components. The described systems and methods may be described in the general context of computer-executable instructions, such as program modules, being executed by one or more computers or other devices. Generally, program modules comprise computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 1001. The components of the computer 1001 may comprise, but are not limited to, one or more processors or processing units 1003, a system memory 1012, and a system bus 1013 that couples various system components including the processing unit 1003 to the system memory 1012. In the case of multiple processing units 1003, the system may utilize parallel computing.

The system bus 1013 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnects (PCI), a PCI-Express bus, a Personal Computer Memory Card Industry Association (PCMCIA), Universal Serial Bus (USB) and the like. The bus 1013, and all buses specified in this description may also be implemented over a wired or wireless network connection and each of the subsystems, including the processing unit 1003, a mass storage device 1004, an operating system 1005, 3D visualization software 1006, 3D visualization data 1007, a network adapter 1008, system memory 1012, an Input/Output Interface 1010, a display adapter 1009, a display device 1011, and a human-machine interface 1002, may be contained within one or more remote computing devices 1014A,B,C at physically separate locations, connected through buses of this form, in effect implementing a fully distributed system.

The computer 1001 typically comprises a variety of computer-readable media. Examples of computer-readable media may be any available media that is accessible by the computer 1001 and comprises, for example, both volatile and non-volatile media, removable and non-removable media. The system memory 1012 comprises computer-readable media in the form of volatile memory, such as random-access memory (RAM), and/or non-volatile memory, such as read only memory (ROM). The system memory 1012 typically contains data such as 3D visualization data 1007 and/or program modules such as operating system 1005 and 3D visualization software 1006 that are immediately accessible to and/or are presently operated on by the processing unit 1003. The 3D visualization software 1006 may perform the methods described in FIGS. 3-8.

In another aspect, the computer 1001 may also comprise other removable/non-removable, volatile/non-volatile computer storage media. By way of example, FIG. 10 illustrates a mass storage device 1004 which may provide non-volatile storage of computer code, computer-readable instructions, data structures, program modules, and other data for the computer 1001. For example, a mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 1004, including by way of example, an operating system 1005 and 3D visualization software 1006. Each of the operating system 1005 and 3D visualization software 1006 (or some combination thereof) may comprise elements of the programming and the 3D visualization software 1006. 3D visualization data 1007 may also be stored on the mass storage device 1004. 3D visualization data 1007 may be stored in any of one or more databases known in the art. Examples of such databases may comprise, DB2®, Microsoft® Access, Microsoft® SQL Server, Oracle®, mySQL, PostgreSQL, Mongo DB, Riak, HBase, Cassandra, and the like. The databases may be centralized or distributed across multiple systems.

In another aspect, the user may enter commands and information into the computer 1001 via an input device (not shown). Examples of such input devices may comprise, but are not limited to, a keyboard, a pointing device (e.g., a “mouse”), a microphone, a joystick, a scanner, tactile input devices such as gloves, and other body coverings, and the like These and other input devices may be connected to the processing unit 1003 via a human-machine interface 1002 that is in communication with the system bus 1013, but may be connected by other interface and bus structures, such as a parallel port, game port, an IEEE 1394 Port (also known as a Firewire port), a serial port, or a universal serial bus (USB).

In yet another aspect, a display device 1011 may also be connected to the system bus 1013 via an interface, such as a display adapter 1009. It is contemplated that the computer 1001 may have more than one display adapter 1009 and the computer 1001 may have more than one display device 1011. For example, a display device may be a monitor, an LCD (Liquid Crystal Display), or a projector. In addition to the display device 1011, other output peripheral devices may comprise components such as speakers (not shown) and a printer (not shown) which may be connected to the computer 1001 via Input/Output Interface 1010. Any step and/or result of the methods may be output in any form to an output device. Such output may be any form of visual representation, including, but not limited to, textual, graphical, animation, audio, tactile, and the like. The display 1011 and computer 1001 may be part of one device, or separate devices.

The computer 1001 may operate in a networked environment using logical connections to one or more remote computing devices 1014A,B,C. By way of example, a remote computing device may be a user device 102, 104, a network device, personal computer, portable computer, smartphone, a head-mounted display (HMD) device a server, a router, a network computer, a peer device or other common network node, and so on. Logical connections between the computer 1001 and a remote computing device 1014A,B,C may be made via a network 1015, such as a local area network (LAN) and/or a general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components reside at various times in different storage components of the computer 1001, and are executed by the data processor(s) of the computer. An implementation of 3D visualization software 1006 may be stored on or transmitted across some form of computer-readable media. Any of the described methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Examples of computer storage media may comprise, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, by a computing device, first data indicative of a structure in a two-dimensional space;
receiving, by the computing device, second data indicative of one or more assets associated with a geolocation of the structure in a three-dimensional representation of the Earth's surface;
determining, based on the first data and the second data, a three-dimensional model comprising the structure and the one or more assets from a perspective of the structure, wherein the structure and the one or more assets are aligned to respective geolocation in the three-dimensional representation of the Earth's space;
causing output of the three-dimensional model in a three-dimensional virtual space via a virtual reality platform of a user device; and
updating, based the three-dimensional model and based on a request from the user device, one or more features associated with the three-dimensional model.

2. The method of claim 1, wherein the first data comprises floor plan information, dimension information, elevation information, structural element information, and material specification information.

3. The method of claim 1, wherein the one or more assets comprise one or more terminal buildings, one or more runways, one or more taxiways, one or more aprons, one or more control towers, one or more hangars, and one or more cargo facilities.

4. The method of claim 1, further comprising:
updating, based the three-dimensional model and based on the request from the user device, the one or more features associated with the one or more assets.

5. The method of claim 1, wherein the second data comprises geospatial data, survey data, structure data, and environment data associated with a predetermined area of the geolocation of the structure.

6. The method of claim 1, wherein the one or more features associated with the structure comprise one or more of a plane feature, a tower feature, a cabinetry feature, a weather feature, or a site feature.

7. The method of claim 6, wherein the plane feature further comprises one or more plane identities, one or more runways, one or more traffic patterns, and one or more taxiways.

8. The method of claim 7, further comprising:
receiving, from the user device, the request indicative of the plane feature to update, wherein the request comprises a plane identity of the one or more plane identities, a runway of the one or more runways, a traffic pattern of the one or more traffic patterns, or a taxiway of the one or more taxiways; and
updating, based on one or more of the plane identity, the runway, the traffic pattern, or the taxiway, one or more of the plane feature of the three-dimensional model.

9. The method of claim 6, wherein the tower feature further comprises a latitude, a longitude, an elevation, a height, a rotation, and a position associated with the structure.

10. The method of claim 9, further comprising:
receiving, from the user device, the request indicative of the tower feature to update, wherein the request comprises the latitude, the longitude, the elevation, the height, the rotation, and the position; and
updating, based on one or more of the latitude, the longitude, the elevation, the height, the rotation, or the position, one or more of the tower feature of the three-dimensional model.

11. The method of claim 6, wherein the cabinetry feature further comprises one or more window settings, one or more staircase settings, and one or more casework settings, and the method further comprising:
receiving, from the user device, the request indicative of the cabinetry feature to update, wherein the request comprises a window setting of the one or more window settings, a staircase setting of the one or more staircase settings, and a casework setting of the one or more casework settings; and
updating, based on one or more of the window setting, the staircase setting, or the casework setting, one or more of the cabinetry feature of the three-dimensional model.

12. The method of claim 6, wherein the weather feature further comprises a date, a time, a location, a time zone, cloud coverage, fog, rain, snow, sand/dust, wind intensity, and thunder/lightning, and wherein the method further comprising:
receiving, from the user device, the request indicative of the weather feature to update, wherein the request comprises the date, the time, the location, the time zone, the cloud coverage, the fog, the rain, the snow, the sand/dust, the wind intensity, and the thunder/lightning; and
updating, based on one or more of the date, the time, the location, the time zone, the cloud coverage, the fog, the rain, the snow, the sand/dust, the wind intensity, or the thunder/lightning, one or more of the weather feature of the three-dimensional model.

13. The method of claim 6, wherein the site feature further comprises runway marker visibility, taxiway marker visibility, runway light visibility, and tree visibility, and wherein the method further comprising:
receiving, from the user device, the request indicative of the site feature to update, wherein the request comprises site visibility, the runway marker visibility, the taxiway marker visibility, the runway light visibility, and the tree visibility; and
updating, based on one or more of the site visibility, the runway marker visibility, the taxiway marker visibility, the runway light visibility, or the tree visibility, one or more of the site feature of the three-dimensional model.

14. The method of claim 1, wherein updating the one or more features is performed in real-time.

15. The method of claim 1, wherein the structure is an airport control tower, a transportation hub, a college building, a military base, a museum, or a structure in a park.

16. An apparatus comprising:
one or more processors; and
a memory storing processor-executable instructions that, when executed by the one or more processors, cause the apparatus to:
receive first data indicative of a structure in a two-dimensional space;
receive second data indicative of one or more assets associated with a geolocation of the structure in a three-dimensional representation of the Earth's surface;
determine, based on the first data and the second data, a three-dimensional model comprising the structure and the one or more assets from a perspective of the structure, wherein the structure and the one or more assets are aligned to respective geolocation in the three-dimensional representation of the Earth's space;
cause output of the three-dimensional model in a three-dimensional virtual space via a virtual reality platform of a user device; and
update based the three-dimensional model and based on a request from the user device, one or more features associated with the three-dimensional model.

17. The apparatus of claim 16, wherein the first data comprises floor plan information, dimension information, elevation information, structural element information, and material specification information.

18. The apparatus of claim 16, wherein the second data comprise geospatial data, survey data, structure data, and environment data associated with a predetermined area of the geolocation of the structure.

19. The apparatus of claim 16, wherein the one or more features associated with the structure comprise one or more of a plane feature, a tower feature, a cabinetry feature, a weather feature, or a site feature.

20. A system comprising:
a computing devices configured to:
receive first data indicative of a structure in a two-dimensional space;
receive second data indicative of one or more assets associated with a geolocation of the structure in a three-dimensional representation of the Earth's surface;
determine, based on the first data and the second data, a three-dimensional model comprising the structure and the one or more assets from a perspective of the structure, wherein the structure and the one or more assets are aligned to respective geolocation in the three-dimensional representation of the Earth's space;
cause output of the three-dimensional model in a three-dimensional virtual space via a virtual reality platform of a user device; and
update, based the three-dimensional model and based on a request from the user device, one or more features associated with the structure; and
the user device configured to:
send the request to update the one or more features.
